(19) United States
(12) Patent Application Publication
(10) Pub. No.: US 2010/0178914 A1
(43) Pub. Date: Jul. 15, 2010

(54) SYSTEM AND METHOD OF DELIVERING CONTENT FROM A WIRELESS COMMUNICATION UNIT

(75) Inventors: Larry G. Fischer, Waseca, MN (US); Jamie Brown, Prior Lake, MN (US); Mahesh Patel, Streamwood, IL (US); Tony Lefebvre, Edina, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/351,055

(22) Filed: Jan. 9, 2009

(51) Int. Cl. H04W 4/00; H04B 1/38; H04M 1/00

(52) U.S. Cl. 455/426.1; 455/73; 455/550.1

(57) ABSTRACT

In one embodiment, a wireless communication unit is provided. The wireless communication unit comprises a transceiver operable to transmit to and receive wireless signals from one or more wireless devices in a service area of the wireless communication unit; a controller operable to manage operation of the transceiver and to obtain and store connection information for each of the one or more wireless devices; and a cache operable to store location-based data associated with the service area of the wireless communication unit. The controller is further operable to push location-based data from the cache to at least a subset of the one or more wireless devices using the stored connection information for the subset of the one or more wireless devices.

### CROSS-REFERENCE TO RELATED APPLICATIONS

This application is related to the following co-pending U.S. patent applications filed on even date herewith, all of which are hereby incorporated herein by reference:

U.S. patent application Ser. No. ______ (attorney docket number 100.864US01 entitled “SYSTEM AND METHOD OF DELIVERING CONTENT USING NETWORKED WIRELESS COMMUNICATION UNITS”) and which is referred to herein as the '864 Application;

U.S. patent application Ser. No. ______ (attorney docket number 100.918US01 entitled “SYSTEM AND METHOD OF DELIVERING CONTENT OVER A LOCAL WIRELESS SYSTEM”) and which is referred to herein as the '918 Application;

### BACKGROUND

Wireless communication has become increasingly popular and accessible. In particular, wireless technology is currently available which enables a user to access and receive non-real-time data over a wireless network using a wireless device such as a cell phone or a laptop computer. For example, users can access the internet, email, etc. using a wireless device. Non-real-time data, such as web pages, music, etc. is typically stored on content servers and accessed via a data network such as the internet Additionally, many services use wireless technology to provide users with location-based data. Various techniques have been developed to determine a user's location and provide content, such as advertisements, based on the user's location.

However, the ability to access non-real-time data and provide location-based data is placing increasing burdens on the available bandwidth of conventional wireless networks such as Global System for Mobile communications (GSM) networks. The increased bandwidth burden may lead to more dropped calls and poorer service quality similar to the problems experienced by landline telephone service providers shortly after the advent of internet access via phone lines. One possible solution to the problem of bandwidth burden is to limit or cut off access to non-real-time data for users with high-volumes of non-real-time data traffic. This solution, however, may cause a decline in subscribers and does not answer the growing demand for access to non-real-time data over wireless networks.

For the reasons stated above and for reasons that shall become apparent to one of ordinary skill in the art upon reading and studying the present application, there is a need in the art for a system which relieves the bandwidth burden placed on wireless networks.

### SUMMARY

In one embodiment, a wireless communication unit is provided. The wireless communication unit comprises a transceiver operable to transmit to and receive wireless signals from one or more wireless devices in a service area of the wireless communication unit; a controller operable to manage operation of the transceiver and to obtain and store connection information for each of the one or more wireless devices; and a cache operable to store location-based data associated with the service area of the wireless communication unit. The controller is further operable to push location-based data from the cache to at least a subset of the one or more wireless devices using the stored connection information for the subset of the one or more wireless devices.

### DRAWINGS

FIG. 1 is a block diagram showing one embodiment of a wireless network.

FIG. 2 is a flow chart depicting one embodiment of a method of providing content to a wireless device.

FIG. 3 is a flow chart depicting one embodiment of a method of building/maintaining the identity of wireless devices.

FIG. 4 is a flow chart depicting one embodiment of a method of pushing location-based data to wireless devices.

FIG. 5 is a flow chart depicting one embodiment of a method of providing requested non-real-time data to wireless devices.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures or the specification is not to be construed as limiting the order in which the individual steps may be performed. The following detailed description is, therefore, not to be taken in a limiting sense.

Some embodiments reduce the bandwidth burden placed on a wireless network due to non-real-time data traffic. In particular, some embodiments enable delivery of both cached non-real-time data and push content to a wireless device from a wireless communication unit without the need to retrieve the data from a content server over the wireless network. As used herein, real-time data is defined as data which is transmitted at substantially the same time as it is created, such as voice data and text messages. Hence, non-real-time data, such as web pages, music, etc., is defined as data which is not transmitted at substantially the same time as it is created. In other words, non-real-time data is data which is stored for later access or transmission. In addition, the term “push” is defined as initiating the provision of content without waiting for a data request from the subscriber's wireless device.

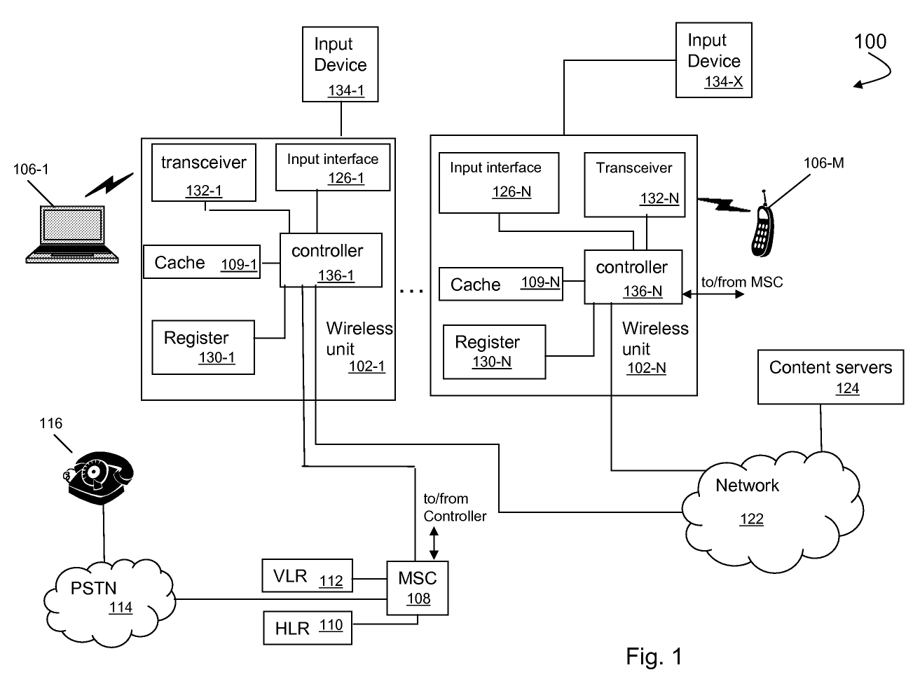

FIG. 1 is a block diagram of one embodiment of a wireless network 100. Network 100 reduces the bandwidth burden for delivery of non-real-time content to wireless devices 106-1 . . . 106-M compared to a conventional wireless network. In the exemplary embodiment shown in network 100, wireless communication units 102-1 . . . 102-N are implemented as GSM base station transceivers (BTS). However, although network 100 is shown and described in relation to a GSM network, it is to be understood that other wireless technologies can be used in other embodiments, such as Universal Mobile Telecommunications System (UMTS), Worldwide Interoperability for Microwave Access (WiMAX), Code Division Multiple Access 2000 (CDMA2000), Ultra Mobile Broadband (UMB), and Long Term Evolution (LTE). For example, wireless communication units 102-1 . . . 102-N can be implemented as Radio Network Controllers (RNC) in a UMTS network or as Access Service Network (ASN) Base Stations (BS) in a WiMAX network.

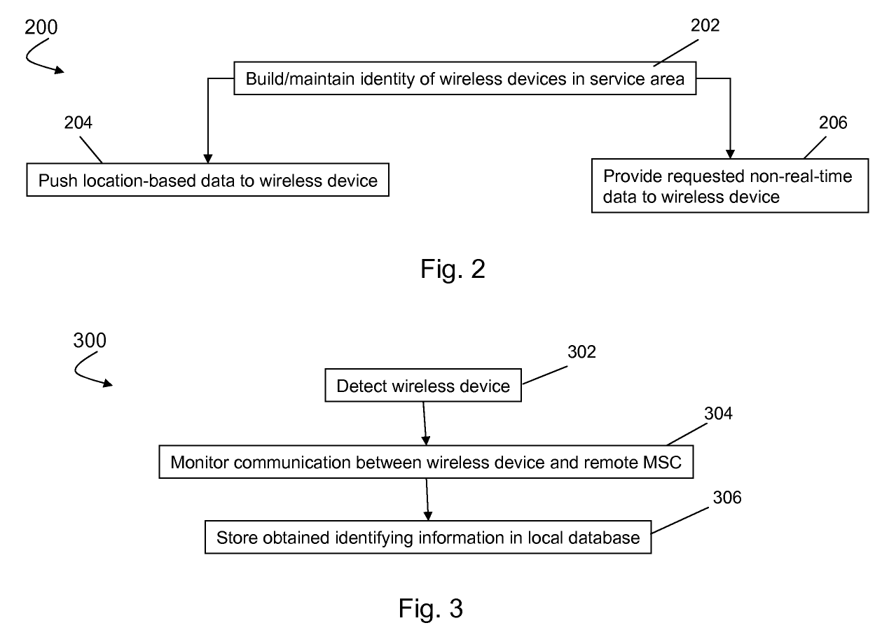

Wireless communication units 102-1 . . . 102-N each comprise a transceiver 132 for transmitting and receiving wireless signals from a plurality of mobile devices 106-1 . . . 106-M. Although only two wireless communication units 102 are shown in FIG. 2, it is to be understood that any number of wireless communication units 102 can be used in other embodiments. Each wireless communication unit 102-1 . . . 102-N also comprises a cache 109-1 . . . 109-N and a controller 136-1 . . . 136-N, respectively.

Controller 136 is operable to implement base station controller functionality to manage operation of the transceiver 132. In addition, controller 136 is operable to implement functionality of a gateway node. That is, controller 136 is operable to process data packets and provide an interface to a packet data network 122. For example, in the exemplary embodiment of FIG. 2, controller 136 implements the functionality of a Serving General Packet Radio Service (GPRS) Support Node (GGSN) and a Gateway GPRS Support Node (GGSN). The gateway node functionality can be implemented as a plurality of computational cards each with a specific function. In other embodiments, controller 136 implements gateway node functionality appropriate for other wireless technologies. For example, in an alternative embodiment in which a WiMAX network is used, controller 136 implements the functionality of an Access Service Network (ASN) gateway. Thus, including gateway node functionality in each wireless communication unit 102-1 . . . 102-N distributes the gateway node in network 100, whereas conventional wireless network utilize a centralized gateway node for a plurality of communication units.

In implementing gateway node functionality, controller 136 processes user initiated requests for non-real time data received from wireless devices 106-1 . . . 106-M. In processing the data requests, controller 136 determines if the requested data is stored in the local cache 109 coupled to controller 136 in the respective wireless communication units 102. If the requested data is located in cache 109, the requested data is provided to the wireless device from cache 109 rather than over the network 100 from content servers 124. Thus, the bandwidth burden on the network 100 associated with non-real-time data, such as video and music files, is reduced.

The non-real-time data to be stored in each cache 109-1 . . . 109-N is selected, in some embodiments, based on actual requests received from wireless devices 106-1 . . . 106-M. For example, in one embodiment, cache 109-1 . . . 109-N are each updated by deleting the last accessed data with more recently accessed data. In this way, data that is requested more often is kept in cache 109-1 . . . 109-N to improve performance. In other embodiments, the data to be stored is also determined by anticipating requests. In other words, if a history of requests indicates that a particular file or data is typically requested frequently, cache 109-1 . . . 109-N can store that data prior to any actual requests in anticipation of the frequent requests. For example, if a history of requests indicates that a given news site is accessed by many users each morning, each wireless communication unit 102-1 . . . 102-N caches the given news site each morning prior to receiving any requests in anticipation of requests for the news site.

Additionally, in some embodiments, controllers 136-1 . . . 136-N in wireless communication units 102-1 . . . 102-N, respectively, each include some functionality of other core network components. Core network components are components which provide authentication services, routing of real-time data (e.g. voice calls) and/or an interface to a circuit-switched network such as the Public Switched Telephone Network (PSTN) 114. For example, in FIG. 1, each controller 136-1 . . . 136-N includes functionality of a mobile switching center (MSC) in a GSM network. By including functionality of core network components in each wireless communication unit 102-1 . . . 102-N, bandwidth burdens on the network 100 are further reduced.

In particular, wireless communication units 102-1 . . . 102-N are able to obtain connection information for wireless devices 106-1 . . . 106-M. Connection information includes, but is not limited to, the assigned transmit frequency for transmitting to the wireless device and an identification number such as the Mobile Subscriber Integrated Services Digital Network (MSISDN) number. In one embodiment, each wireless communication unit 102-1 . . . 102-N obtains the connection information by monitoring communication between each wireless device 106-1 . . . 106-M and remote MSC 108 during authentication or handoff procedures

Wireless communication units 102-1 . . . 102-N initiate delivery of location-based data to wireless devices 106-1 . . . 106-M (also referred to as pushing content). That is, in addition to waiting for a user initiated request (also referred to as pull content) as described above, wireless communication units 102-1 . . . 102-N are also operable to provide content to wireless devices 106-1 . . . 106-M based upon criteria other than a user initiated request.

Location-based data is data associated with the area in which the wireless device is located. Location-based data includes, but is not limited to, advertisements and/or coupons for goods and services sold in the area; local news or notices, such as campus headlines or notice that a particular class is canceled; emergency alerts, such as Amber alerts or other safety notices. Thus, location-based data is stored on cache 109-1 . . . 109-M and pushed to wireless device 106-1 . . . 106-M not as a response to a user request, but as a response to other conditions, such as detection of the wireless device in a service area of a wireless communication unit 102 or receipt of an instruction from an input device, such as input device 134-1 . . . 134-N.

In operation, when a wireless device, such as wireless device 106-M, attaches to network 100, authentication procedures known to one of skill in the art are performed between wireless device 106-M and MSC 108. During the authentication procedures, connection information of wireless device 106-M, such as the Electronic Serial Number (ESN) and Mobile Identification Number (MIN), are retrieved from HLR 110 and stored in VLR 112 which services wireless communication units 102-1 . . . 102-N. Notably, although only one VLR 112 and MSC 108 is shown in FIG. 1, it is to be understood that in other embodiments, multiple visitor location registers (VLR) 112 and MSC 108 can be used.

Controller 136-N, which is servicing the area in which wireless device 106-M is located, monitors communications between MSC 108 and wireless device 106-M during the authentication procedures to obtain the connection information of wireless device 106-M. Controller 136-N stores the connection information for wireless device 106-M in register 130-N. Similarly, during handoff procedures, the connection information is obtained by the controller 136 of the target wireless communication unit (e.g. the new wireless communication unit) and stored in the register 130 of the target wireless communication unit 102. After the authentication or handoff procedures are complete, wireless communication unit 102-N uses the connection information stored in register 130 to push location-based data, if applicable, to wireless device 106-M from cache 109-N. In particular, controller 136-N uses the assigned transmit frequency to direct transceiver 132-N in pushing location-based data to wireless devices 106-M.

For example, in some embodiments, wireless communication units 102-1 . . . 102-N are operable to push location-based data to wireless devices 106-1 . . . 106-M upon detection of wireless devices 106-1 . . . 106-M in the service area of the corresponding wireless communication unit 102-1 . . . 102-N. Alternatively, additional criteria may be used in other embodiments. For example, in one alternative embodiment, a user may sign up to receive location-based data, such as coupons. In some such embodiments, the controller 136-1 . . . 136-N checks a list of registered wireless devices stored on cache 109-1 . . . 109-N, respectively, when a wireless device 106 is detected. When a wireless device 106 is detected in a service area of one of wireless communication units 102-1 . . . 102-N, the corresponding wireless communication unit checks the list of registered wireless devices for each detected wireless device 106-1 . . . 106-M. If the list of registered wireless devices indicates that a detected wireless device 106 is to receive the location-based data, the corresponding wireless communication unit pushes the location-based data to that wireless device 106.

Another exemplary criterion for pushing location-based data is receiving an instruction to push data. In some embodiments, wireless communication units 102-1 . . . 102-N include an input interface 126-1 . . . 126-N, respectively, to receive instructions from input device 134-1 . . . 134-N. Input device 134-1 . . . 134-X are located in a central location, in some embodiments, and can be coupled to an input interface 126 of more than one wireless communication unit 102. Input device 134-1 . . . 134-X are used to provide location-based data and instructions to push location-based data. For example, in an emergency situation, such as a child kidnapping, input device 134-1 . . . 134-X are used to provide Amber alert information to wireless communication units 102-1 . . . 102-N and to instruct wireless communication units 102-1 . . . 102-N to push the alert information to wireless devices 106-1 . . . 106-M. The location-based data provided by input device 134-1 . . . 134-X is stored on the respective cache 109-1 . . . 109-M in some embodiments.

In addition, in some embodiments, wireless communication units 102-1 . . . 102-N deliver user requested non-real-time data to wireless devices 106-1 . . . 106-M from cache 109-1 . . . 109-N, respectively, when available as described above. If the user-requested non-real-time data is not stored in cache 109-1 . . . 109-N of the respective wireless communication unit 102 processing the request, the non-real-time data request is sent over the network 100 to retrieve the data from content servers 124. Data from content servers 124 is sent over network 200 and provided to wireless devices 106-1 . . . 106-M via controllers 136-1 . . . 136-M, respectively, which implement the functionality of GGSN and SGSN.

FIG. 2 is a flow chart showing one embodiment of a method 200 of providing data to a wireless device. Method 200 is implemented in a wireless network such as network 100 described above. At 202, the wireless communication unit builds and maintains a list of the identities of wireless devices in the service area of the wireless communication unit. The information in the list of identities includes the transmit frequency assigned to the wireless devices along with identification numbers, such as the Electronic Serial Number (ESN) and Mobile Identification Number (MIN). An exemplary method of building/maintaining a list of wireless device identities is described in more detail in FIG. 3.

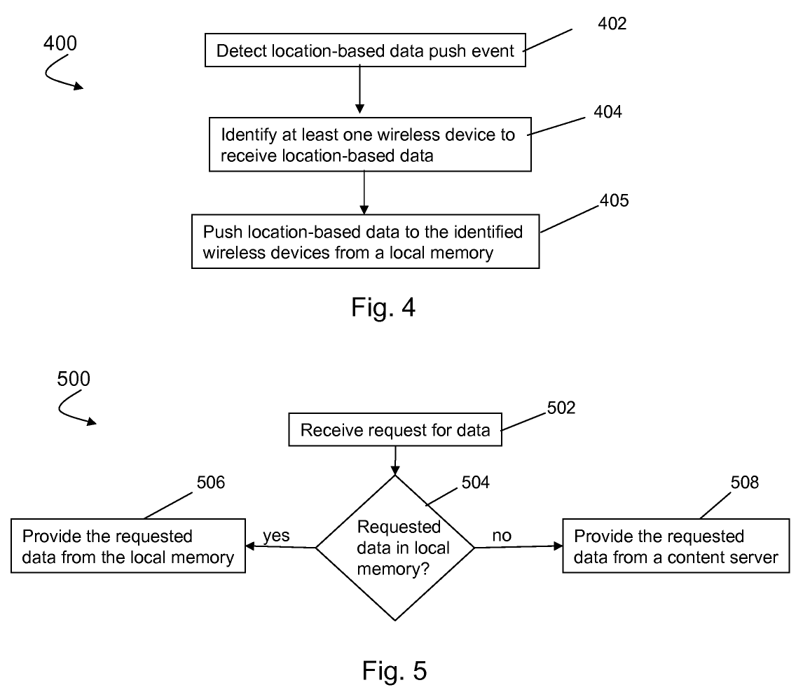

At 204, the information in the list of identities is used to push location-based data from a local cache in the wireless communication unit to at least one wireless device in the service area of the wireless communication unit. An exemplary method of pushing location-based data is described in more detail in FIG. 4. At 206, requested non-real-time data is provided to the wireless devices. In particular, the requested non-real-time data is provided from the local cache in the wireless communication unit if available. An exemplary method of providing requested non-real-time data is discussed in more detail in FIG. 5.

FIG. 3 is a flow chart depicting one embodiment of a method 300 of building/maintaining the identity of wireless devices. At 302, a wireless device (e.g. wireless device 106) is detected in a service area of a base transceiver station, such as wireless communication unit 102. For example, the wireless device is detected during handoff procedures from another wireless communication unit. The wireless device can also be detected when the wireless device is powered on while in the service area of the wireless communication unit.

At 304, a controller (e.g. controller 136) located in the wireless communication unit monitors communication between the detected wireless device and a remote mobile switching center. By monitoring the communication, the controller obtains the connection information such as the ESN and MIN. The controller also obtains the assigned transmit frequency for transmitting signals to the detected wireless device. At 306, the obtained connection information is stored in a local register (e.g. register 130) located in the wireless communication unit.

FIG. 4 is a flow chart depicting one embodiment of a method 400 of pushing location-based data to wireless devices. At 402, a push event is detected. Exemplary push events include detecting a wireless device in the service area of the wireless communication unit and receiving a command from an input device (e.g. input device 134). For example, in some embodiments, the location-based data is pushed to the wireless device based on the wireless device being registered to receive location-based data. In such embodiments, the wireless communication unit checks a list to determine if the detected wireless device is registered. If the wireless device is registered, the wireless communication unit pushes the location-based data to the registered wireless device. If not, the wireless communication unit does not push the location-based data.

In other embodiments, the wireless communication unit pushes the location-based data upon receiving an instruction to push the data. For example, in some such embodiments, emergency alerts are provided to the wireless communication unit via an input interface. The wireless communication unit waits until receiving an instruction over the input interface to push the emergency alerts to the detected wireless device.

At 404, at least one wireless device in the service area of the wireless communication unit is identified for receiving the pushed location-based data. For example, in some embodiments, the wireless communication unit checks a list of wireless devices registered to receive pushed location-based data. A user can register a wireless device, for example, by sending a text message to specific address or through an on-line web interface. At 406, the wireless communication unit pushes the location-based data from a local cache in the wireless communication unit to the at least one identified wireless device using identity information stored in the wireless communication unit.

FIG. 5 is a flow chart depicting a method 500 of providing requested non-real-time data to wireless devices according to one embodiment of the present invention. At 502, a request for non-real-time data is received at the wireless communication unit from a wireless device. At 504, it is determined if the requested non-real-time is stored in the local cache in the wireless communication unit. If the requested non-real-time is stored in the local cache, the wireless communication unit provides the requested data to the wireless device from the local cache at 506. If the requested non-real-time data is not stored in the local cache, the wireless communication unit passes the request over a network (e.g. network 100) in order to provide the requested non-real-time data from a content server (e.g. content server 124) at 508.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1 A wireless communication unit comprising:
a transceiver to transmit to and receive wireless signals from one or more wireless devices in a service area of the wireless communication unit;
a controller to manage operation of the transceiver and to obtain and store connection information for each of the one or more wireless devices; and
a cache to store location-based data associated with the service area of the wireless communication unit;
wherein the controller is further operable to push location-based data from the cache to at least a subset of the one or more wireless devices using the stored connection information for the subset of the one or more wireless devices.

2. The wireless communication unit of claim 1, wherein the controller is further operable to push content to each of the one or more wireless devices when each of the one or more wireless devices is detected in the service area of the wireless communication unit.

3. The wireless communication unit of claim 1, wherein the controller is further operable to push location-based data to at least the subset of the one or more wireless devices upon receiving an instruction from an input device.

4. The wireless communication unit of claim 1, wherein the controller is further operable to provide non-real-time data to the one or more wireless devices from the cache in response to a request from the one or more wireless devices.

5. The wireless communication unit of claim 1, wherein the controller is operable to check a list of registered wireless devices and to push location-based data only to the registered wireless devices.

6. The wireless communication unit of claim 1, wherein the wireless communication unit is a Global System for Mobile communications (GSM) base transceiver station.

7. The wireless communication unit of claim 1, wherein the location-based data stored on the cache includes one or more of advertisements, emergency alerts, coupons, and news.

8. A wireless communication network comprising:
a plurality of wireless communication units, each of the plurality of wireless communication units comprising:
a transceiver to transmit to and receive wireless signals from one or more wireless devices in a service area of the at least one wireless communication unit;
a controller to manage operation of the transceiver and to obtain and store connection information for each of the one or more wireless devices; and
a cache to store location-based data associated with the service area of the at least one wireless communication unit;
wherein the controller is further operable to push location-based data from the cache to at least a subset of the one or more wireless devices using the stored connection information for the subset of the one or more wireless devices; and
a core network operable to route real-time data between the wireless devices located in the respective service areas of the plurality of wireless communication unit.

9. The wireless communication network of claim 8, wherein the controller is further operable to push location-based data to each of the one or more wireless devices when each of the one or more wireless devices is detected in the service area of the at least one of the plurality of wireless communication unit.

10. The wireless communication network of claim 8, further comprising an input device, wherein the controller is further operable to push location-based data to at least the subset of the one or more wireless devices upon receiving an instruction from the input device.

11. The wireless communication network of claim 8, wherein the communication network is a Global System for Mobile communications (GSM) network.

12. The wireless communication network of claim 8, wherein the controller is operable to check a list of registered wireless devices and to push location-based data only to the registered wireless devices.

13. The wireless communication network of claim 8, wherein the controller is further operable to provide non-real-time data to the one or more wireless devices from the cache in response to a request from the one or more wireless devices.

14. The wireless communication network of claim 13, wherein the controller is further operable to provide non-real-time data obtained from a content server in response to a request from the one or more wireless devices if the data is not available in the cache.

15. A method of providing data to a wireless device from a wireless communication unit, the method comprising:
detecting the wireless device in a service area of the wireless communication unit;
obtaining connection information for the wireless device;
storing the connection information in the wireless communication unit; and
pushing location-based data to the wireless device from a local cache in the wireless communication unit using the stored connection information.

16. The method of claim 15, wherein pushing the location-based data further comprises:
detecting a location-based data push event in the wireless communication unit; and
identifying at least one wireless device to receive the location-based data.

17. The method of claim 16, wherein detecting a location-based data push event comprises one of:
receiving an instruction from an input device to push location-based data; and
detecting the wireless device in a service area of the wireless communication unit

18. The method of claim 16, wherein identifying at least one wireless device to receive location-based data comprises checking a list of wireless devices registered to receive location-based data.

19. The method of claim 15, further comprising:
receiving a request for non-real-time data;
determining if the non-real-time data is stored on a local cache in the wireless communication unit; and
providing the requested non-real-time data to the wireless device from the local cache if the requested non-real-time data is stored on the local cache.

20. The method of claim 19, further comprising providing the requested non-real-time data from a content server if the requested non-real-time data in is not stored on the local cache.

21. The method of claim 15, wherein obtaining connection information for the wireless device comprises monitoring communications between the wireless device and a remote mobile switching center.
